(19) United States
(12) Patent Application Publication
(10) Pub. No.: US 2011/0106604 A1
(43) Pub. Date: May 5, 2011

(54) Method and System for Providing Digital Incentives

(76) Inventors: Eric REUTHE, Franklin, TN (US); Ed Braswell, Nashville, TN (US); Jonathan Dyke, Washington, DC (US)

(21) Appl. No.: 12/608,082

(22) Filed: Oct. 29, 2009

(51) Int. Cl. G06Q 30/00; G06Q 40/00

(52) U.S. Cl. 705/14.23

(57) ABSTRACT

Systems and methods for providing digital incentives or financial offsets including the steps of: providing a financial platform operable on a server computer and at least one database in electronic, digital communication over a network, the financial platform operable for financial services transactions; providing a database of profile data for the at least one user; developing a digital incentive program for stimulating financial transactions by at least one user, the digital incentive program including profile factors from the profile data of the at least one user; automatically providing at least one digital incentive to corresponding of the at least one user, the at least one digital incentive available for a redemption by each of the users, wherein the digital incentive has an electronic financial transaction value available for the redemption on any electronic financial transaction media, and wherein the redemption of the electronic financial transaction value of the digital incentive does not occur at a merchant level of the financial transactions.

### BACKGROUND OF THE INVENTION

1. Field of the Invention

The present invention relates generally to financial systems and methods. Further, the present invention relates to digital incentives for electronic financial transactions and systems and methods relating thereto.

2. Description of the Prior Art

Merchants and service providers often utilize various forms of incentives to attract new customers and to gain repeat business with prior customers. These incentives generally range from traditional paper coupons to rewards programs that incentivize customer loyalty by awarding customers reward currency for qualifying transactions and allowing customers to redeem accumulated reward currency for discounts, merchandise, or other benefits.

Merchants and manufacturers have long used paper coupons to provide potential customers with incentives to patronize a specific store or to purchase particular products or services. Paper coupons are often delivered through the mail, newspapers, store flyers, and printers located at checkout counters. More recently, email and websites have also been used to deliver coupons for printing. In addition, online merchants regularly provide online coupons, known as coupon codes, for use at the checkout phase of an online purchase. Furthermore, some merchants now send coupons directly to consumers' mobile phones as text messages. Finally, some merchants utilize closed-loop loyalty card systems in which customers are provided loyalty cards associated with loyalty accounts and the merchants can automatically deliver coupons to the associated accounts.

Coupons, in all forms, allow merchants to provide incentives to potential customers. For customers, coupons provide a benefit at the time of purchase, not at some later time, as is typically the case with rewards programs based on reward currency accumulation. However, coupons have several disadvantages. Paper coupons require that the consumer manually collect the coupons, remember to bring the coupons to the appropriate store, and to manually present the coupons at the time of purchase. In addition, paper coupons require merchants to train employees to process the coupons. While coupons delivered automatically to mobile phones and closed-loop loyalty accounts reduce the effort required to collect coupons, consumers are still required to bring their mobile phones or closed-loop loyalty cards to the store in addition to a form of payment in order to receive the benefit of the coupon.

Relevant prior art related to coupons includes the following:

U.S. Pat. No. 4,723,212 entitled “Method and Apparatus for Dispensing Discount Coupons” and issued Feb. 2, 1988, to Mindrum et al. discloses an “apparatus, and a corresponding method, for creating a discount coupon in response to the purchase of a product other than the one to which the coupon applies.”

U.S. Pat. No. 5,649,114 entitled “Method and System for Selective Incentive Point-of-Sale Marketing in Response to Customer Shopping Histories” and issued Jul. 15, 1997, to Deaton et al. discloses entering a customer's identification code, along with customer transaction data, at the point-of-sale, a memory that stores a database of previously entered customer identification codes and transactions data, and a circuitry for generating a signal representative of a customer's shopping history, wherein incentive coupons may be issued to customers in dependence upon the signal.

U.S. Pat. No. 6,076,068 entitled “Coupon Delivery System” and issued Jun. 13, 2000, to DeLapa et al. discloses a “computer-implemented method and apparatus for generating coupons to provide discounts for purchases [which] includes providing a computer-based kiosk at a retail establishment such as a grocery store.”

Prepaid cards are a second form of incentive utilized by merchants. Prepaid cards are debit cards generally purchased by a consumer for later use and are often required to be used at a specific merchant or set of merchants. Consequently, prepaid cards allow merchants to receive money prior to providing any merchandise or service. Once a prepaid card has been purchased, it provides an incentive for the consumer to use it since the expenditure of money has already been made in advance. However, since the prepaid cards generally require consumers to spend money at a time before they receive any goods or services, there is little incentive to purchase a prepaid card outside of a special context, such as gift giving or fundraising. Therefore, prepaid cards often provide little actual incentive for a consumer to patronize a particular merchant or service provider.

In addition to offering prepaid cards for purchase, some merchants use prepaid cards as a method to distribute rewards from their respective customer loyalty and rewards programs. While the prospect of receiving a prepaid card upon achievement of a preset requirement of a loyalty and rewards program provides customer incentive, the benefit to the customer is delayed until a point in time after the time of purchase. This delay is in direct contrast to a coupon-type incentive, which benefits a customer immediately at the point of sale.

Relevant prior art related to prepaid cards include: http://www.parago.com/prepaidcards

Loyalty and rewards programs are popular incentive tools used by merchants and service providers. These programs generally reward customer loyalty by crediting a consumer's rewards account with a reward currency—points, miles, reward dollars, etc.—upon the completion of a qualifying transaction and allowing the consumer to redeem accumulated reward currency for merchandise, services, or discounts. Some loyalty and reward program implementations provide rebates or discounts to the consumer based on the achievement of preset milestones. In general, loyalty and reward programs reward a pattern of customer loyalty performed in the past with a future reward. While these programs provide an incentive for consumers, the consumers must wait until a point in time after one or more purchases have been made before realizing any program-related benefit. Consumers do not receive any immediate benefit at the point of sale as they would with coupon-type incentives.

Traditional implementations of loyalty and rewards programs often issue a separate rewards card to be scanned or swiped at the time of sale in order to credit the rewards account of the customer. Consequently, the consumer is required to carry an additional device to take advantage of the rewards program. In other implementations, merchants partner with banks or credit card companies to issue credit or debit cards with a second magnetic strip. At the time of purchase, a store clerk swipes the card once through a card reader to initiate payment and then performs a second swipe to credit the customer's rewards account. This latter implementation carries with it the disadvantage of requiring store clerks to be trained to perform additional tasks and, depending on the implementation, requiring the merchant to have additional equipment. Other implementations have resolved these issues in the loyalty and rewards context by allowing a single swipe of an individual credit/debit card to initiate payment, credit rewards accounts, and to redeem awards previously earned.

Relevant prior art related to loyalty and reward programs include the following:

U.S. Published Patent Application No. 20090030793 entitled “Multi-Vendor Multi-Loyalty Currency Program” and published Jan. 29, 2009, to Fordyce discloses that “in addition to obtaining payment for the merchant from the account via an acquirer and an issuer, respectively, a transaction handler tabulates and stores, different types of loyalty currencies in a loyalty reward account associated with the account holder if the account holder is enrolled in a loyalty program and criteria for applying the loyalty program are satisfied.”

U.S. Published Patent Application No. 20050240477 entitled “Cardholder Loyalty Program with Rebate” and published Oct. 27, 2005, to Friday et al. discloses a system and method for implementing a program such as a loyalty program. An account (e.g., card) system includes a plurality of participating account holders (e.g., cardholders), a plurality of non-participating account holders (e.g., cardholders), a plurality of non-preferred merchants and a plurality of preferred merchants. A processor executes the program including evaluating transactions to identify qualifying transactions involving both a participating account holders (e.g., cardholders) and a preferred merchant. Rebates are provided for identified, qualifying transactions.

U.S. Pat. No. 5,025,372 entitled “System and Method for Administration of Incentive Award Program Through Use of Credit” and issued Jun. 18, 1991, to Burton et al. discloses “computer data processing, programming and printing for an improved incentive award program which allocates monetary amounts available for expenditure through credit instruments issued to program participants when the participants perform to a designated level of achievement.”

U.S. Published Patent Application No. 20020026348 entitled “Marketing Systems and Methods” and published Feb. 28, 2002, to Fowler et al. discloses “systems and methods implementing a plurality of marketing programs, offered by a plurality of merchants or merchant groups, upon presentation of a qualifying identifier, such as a (single) transaction card. Yet another aspect of the present invention provides methods and systems enabling a “single-swipe” transaction, wherein data is selectively packeted and transmitted to one or more institutions following a single electronic reading of a transaction card.”

Note that marketing programs of the prior art are implemented using a host controller that communicates with a plurality of remote transaction systems to provide real-time, individualized, automated awards and sophisticated multi-variable analysis of transaction data.”

U.S. Published Patent Application No. 20080103968 entitled “Redemption of Credit Card Rewards at Point of Sale” and published May 1, 2008, to Bies et al. discloses “systems and methods . . . for redeeming rewards at a merchant's point-of-sale. The reward redemption takes place in real time and can be accomplished without the active participation of the merchant. A single credit card with no additional information may be used with a single swipe from the consumer to access both credit and rewards accounts, such that a single authorization request is made to encompass both rewards and credit.”

U.S. Published Patent Application No. 20060053056 entitled “Card Member Discount System and Method” and published Mar. 9, 2006, to Alspach-Goss et al. discloses a “method and apparatus to facilitate giving a discount to a consumer subsequent to a point of sale purchase . . . if the purchase qualifies for a discount under one or more discount programs, the consumer's financial account is charged the full, agreed upon purchase price, and subsequently credited one or more discounts the transaction qualifies for without the consumer needing to perform a secondary task(s).”

U.S. Published Patent Application No. 20080235091 entitled “Cash in Advance Incentive and Rewards Program” and published Sep. 25, 2008, to Holliday discloses a system wherein “consumers are provided with a rewards card in advance of earning the rewards through online purchases.”

Note that under the prior art systems consumers must complete transactions before getting reward and then take additional steps proactively in order to receive a rebate; once a preset amount of money is spent a rebate check is issued.

U.S. Published Patent Application No. 20090012862 entitled “Instant Zero Inventory Fulfillment and Redemption System and Method” and published Jan. 8, 2009, to Pirillo et al. discloses an “instant fulfillment system [that] allows members of programs, such as an incentive, reward, affinity or loyalty program, to use an instant reward card to redeem currency or points stored in a database, for instant ‘rebates’ or ‘discounts’ at selected retailers.”

U.S. Published Patent Application No. 20030158818 entitled “Systems and Methods for Operating Loyalty Programs” and published Aug. 21, 2003, to George et al. discloses “A loyalty system that may be integrated with a financial infrastructure . . . . Such a financial infrastructure may accommodate transactions involving participants in the loyalty program as well as transactions that do not involve participants in the loyalty program.”

U.S. Pat. No. 7,506,804 entitled “System and Method for an Integrated Payment and Reward Card” and issued Mar. 24, 2009, to Zajkowski et al. discloses “an integrated rewards card [that] includes a credit card number associated with a credit account of a person, persons, entity or a business. The integrated rewards card also includes a debit card number. The debit card number is different then the credit card number. Purchases using the credit card number cause a reward balance on a reward account associated with the debit card number to be increased. Products or services can be purchased with the reward account using a point of sale device for the credit card number.”

U.S. Published Patent Application No. 20060027647 entitled “System and Method for Redeeming Awards and Incentives” published Feb. 9, 2006, to Deane et al. discloses a “transaction card, including a substrate having a front face and a back face, a first magnetic stripe for storing data associated with a credit account, the first magnetic stripe being located along an edge of the back face, a second magnetic stripe for storing data associated with a rewards account, the second magnetic stripe being located along another edge of the back face, and account information located on the front face, the account information being associated with the credit account and the rewards account.”

While the “single swipe” concept has been utilized in the context of accumulation-based loyalty and rewards programs, a similar solution has not been employed in the context of coupon-type incentives. Because of the need to continuously update reward currency balances with each customer transaction, the benefits of triggering payment and rewards currency accumulation or redemption with a “single swipe” of a single payment device are much more apparent for accumulation-based loyalty and rewards programs than for electronic coupon-type incentive programs, which do not require continuous accounting of reward currency balances upon each transaction with the merchant. Consequently, it is not obvious to apply the “single swipe” methodology to electronic coupon-type incentive program implementations.

In light of the foregoing, there is an apparent need for an incentive implementation that allows merchants to seamlessly deliver electronic coupon-type incentives to potential customers and allows customers to pay for purchases and automatically receive the benefit of the incentives at the time of sale through a “single swipe” of a single payment device.

### SUMMARY OF THE INVENTION

A first aspect of the present invention is to provide a method for providing digital incentives or financial offsets including the steps of: providing a financial platform operable on a server computer and at least one database in electronic, digital communication over a network, the financial platform operable for financial services transactions; providing a database of profile data for the at least one user; developing a digital incentive program for stimulating financial transactions by at least one user, the digital incentive program including profile factors from the profile data of the at least one user; automatically providing at least one digital incentive to corresponding of the at least one user, the at least one digital incentive available for a redemption by each of the users, wherein the digital incentive has an electronic financial transaction value available for the redemption on any electronic financial transaction media, and wherein the redemption of the electronic financial transaction value of the digital incentive does not occur at a merchant level of the financial transactions.

A second aspect of the present invention is to provide a system for providing digital incentives including: a financial system operable on a server computer and at least one database in electronic, digital communication over a network, the financial platform operable for financial services transactions; the financial system interacting with a database of profile data for a multiplicity of users; a digital incentive program operable within the financial system and the server computer for stimulating financial transactions by the users, the digital incentive program including profile factors from the profile data of the users and automatically providing at least one digital incentive to corresponding users, the at least one digital incentive available for a use by each of the users, wherein the digital incentive has an electronic financial transaction value available for the use on any electronic financial transaction media, and wherein the use of the electronic financial transaction value of the digital incentive does not alter the financial transactions for the merchant accepting payment for the transaction.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a schematic diagram view of the system for providing digital incentives of the present invention.

FIG. 2 illustrates a schematic flow diagram of the system and methods for providing digital incentives of the present invention.

FIG. 3 illustrates a schematic diagram of the digital incentive system and switch processing for providing digital incentives of the present invention.

FIG. 4 illustrates another schematic and flow diagram of the digital incentive system and switch processing for providing digital incentives of the present invention.

FIG. 5 illustrates a schematic diagram of the digital incentive system and switch processing for providing digital incentives of the present invention.

### DETAILED DESCRIPTION

The present invention provides a method for providing digital incentives or financial offsets including the steps of: providing a financial platform operable on a server computer and at least one database in electronic, digital communication over a network, the financial platform operable for financial services transactions; providing a database of profile data for the at least one user; developing a digital incentive program for stimulating financial transactions by at least one user, the digital incentive program including profile factors from the profile data of the at least one user; automatically providing at least one digital incentive to corresponding of the at least one user, the at least one digital incentive available for a redemption by each of the users, wherein the digital incentive has an electronic financial transaction value available for the redemption on any electronic financial transaction media, and wherein the redemption of the electronic financial transaction value of the digital incentive does not occur at a merchant level of the financial transactions.

The present invention also provides a system for providing digital incentives including: a financial system operable on a server computer and at least one database in electronic, digital communication over a network, the financial platform operable for financial services transactions; the financial system interacting with a database of profile data for a multiplicity of users; a digital incentive program operable within the financial system and the server computer for stimulating financial transactions by the users, the digital incentive program including profile factors from the profile data of the users and automatically providing at least one digital incentive to corresponding users, the at least one digital incentive available for a use by each of the users, wherein the digital incentive has an electronic financial transaction value available for the use on any electronic financial transaction media, and wherein the use of the electronic financial transaction value of the digital incentive does not alter the financial transactions for the merchant accepting payment for the transaction.

Additionally, the present invention includes a computer readable code stored in a storage medium and executable by one or more processors, which when executed perform the method steps including: automatically providing an electronic communication for at least one digital incentive to a multiplicity of users, the at least one digital incentive available for a redemption by each of the users, applying an electronic financial transaction value available for application triggered by use of the at least one digital incentive by corresponding users, via an electronic financial transaction media; providing a credit for the electronic financial transaction value at a financial institution level for the account, demand deposit account, credit, debit, or prepaid account of the at least one user, without directly affecting a merchant level of the financial transaction.

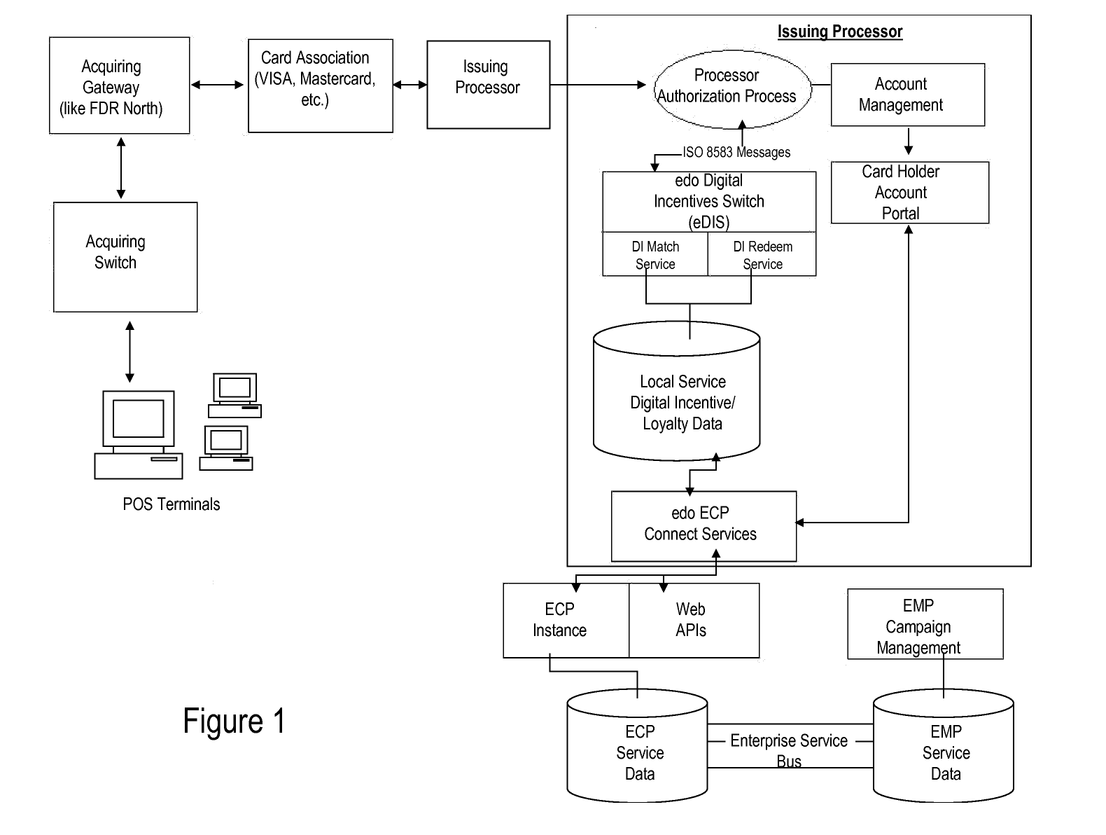

Referring now to the drawings in general, the illustrations are for the purpose of describing preferred embodiments of the invention and are not intended to limit the invention thereto. FIG. 1 illustrates a schematic diagram view of the system for providing digital incentives of the present invention, wherein the digital incentives switch (DIS) is associated with, configured and connected for electronic communication with an issuing processor system. Merchant transactions are initiated at point of sale (POS) terminals, either on location of a merchant or service provider, such as a payment register computer, or online, via a website providing for commercial transactions for goods and/or services order and payment, wherein the website is accessed remotely via a user at a remote computer in electronic communication with a network, such as the Internet, to access the interactive website for input/output of information relating to the transaction through a graphic user interface on the remote computer. The POS terminals automatically communicate electronically via a network with an acquiring switch and an acquiring gateway, and then a card association function and issuing processor system, as illustrated.

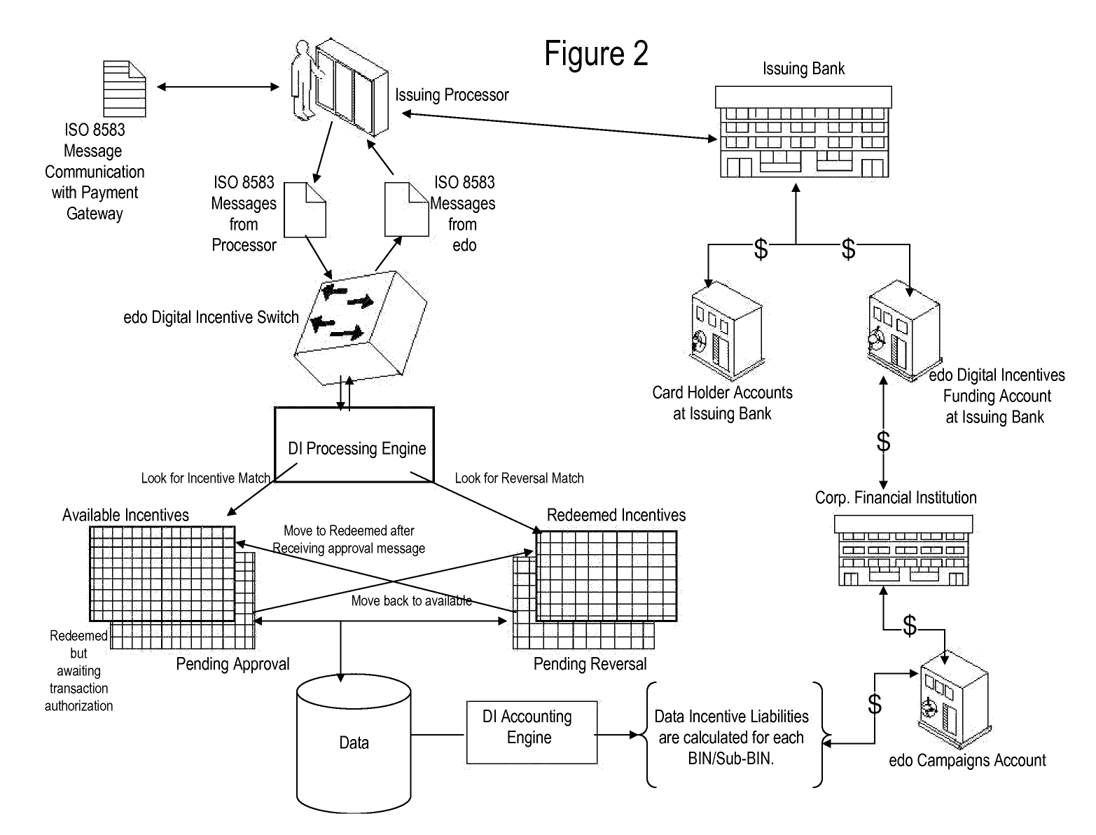

FIG. 2 illustrates a schematic flow diagram of the system and methods for providing digital incentives of the present invention, showing an issuing processor in communication with the digital incentives switch connected to a processing engine, wherein the processing engine is a computer having a processor, memory, power, input/output, and in electronic connection and communication via a network for access to a database having data relating to the digital incentives, including available incentives and redeemed incentives for each account and/or corresponding user. Also, the issuing processor is in networked electronic communication with an issuing bank, having issuing bank account information and data for each card holder(s) or user(s), corresponding cards, corresponding bank accounts. The issuing processor is also at least indirectly connected via networked electronic communication with a digital incentives account that provides for offset(s) to the relevant accounts for which the digital incentives are properly redeemed and matched by the digital incentives switch. The digital incentives switch sends and receives messages from the issuing processor systems, based upon information and/or communication electronically received via a network by the issuing processor from the payment gateway(s) relating to payment and/or approval for transactions proposed by the payment gateway(s) for transactions, typically relating to the purchase of goods and/or services (at a merchant level, also referred to as merchant transactions). The digital incentives switch is operable with the digital incentive (DI) processing engine to identify an available incentive that may be redeemed in association with a matching transaction, based on the information provided by the issuing processor about the proposed transaction by the payment gateway(s).

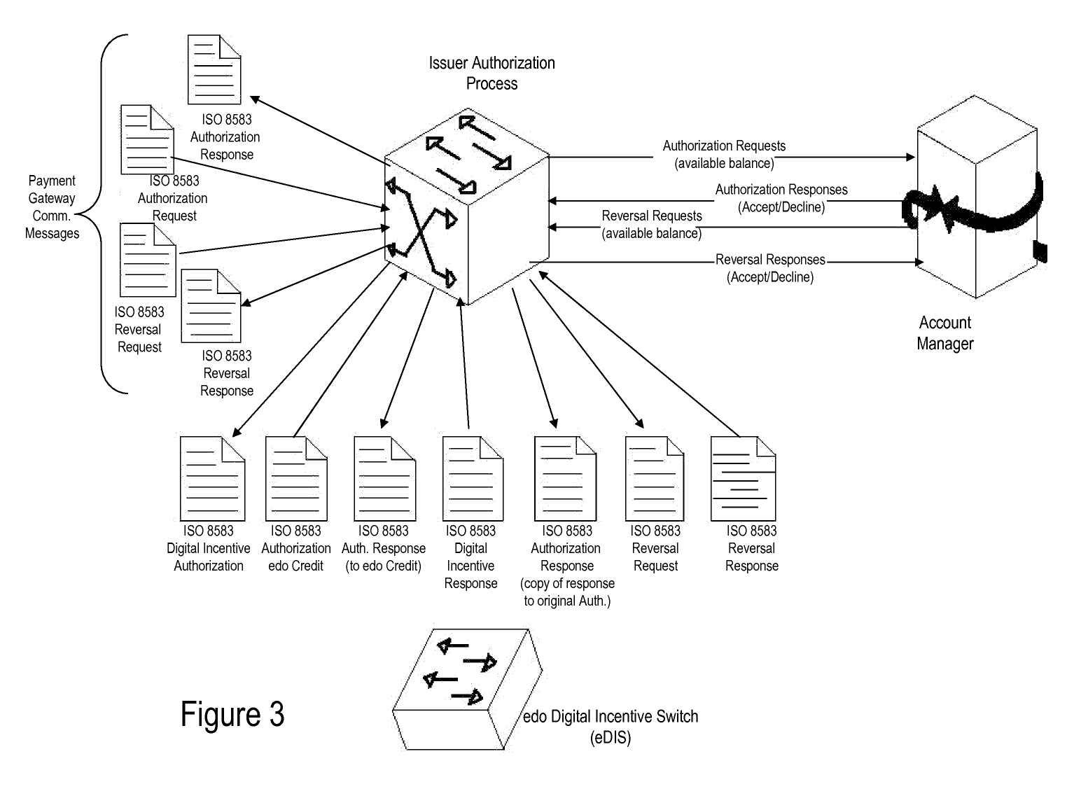

FIG. 3 illustrates a schematic diagram of the digital incentive system and switch processing for providing digital incentives of the present invention. It shows at its center an issuer authorization process box interacting with an accounts management box, for providing authorization requests (available balance), authorization responses (accept/decline), reversal requests (available balance), reversal responses (accept/decline), and combinations thereof; and the issuer authorization process box interacting with a payment gateway communication and/or messages output on the left of the diagram; and interacting with the digital incentives switch of the present invention, illustrated at the bottom of the diagram. The issuer authorization processor includes interactions of: (A1) providing an authorization request from the payment gateway; (A2) providing a digital incentive (DI) authorization message sent electronically via network to the digital incentives switch (DIS) with original authorization data; (A2a) the DIS automatically checks to confirm whether the transaction qualifies for a pre-award or “preward”; (A3) if the transaction qualifies for a preward redemption, then an authorization message for allowing a corresponding offset or credit to the user account (not the merchant level account or transaction) is automatically generated and transmitted from the DIS for the value of the preward; (A4) a response from the issuer authorization processor is provided confirming the offset or credit; (A5) providing a response from DIS confirming the preward authorization and application; alternatively, if not approved by the issuer authorization processor, then (A6) providing an electronic response automatically from the issuer authorization processor confirming the original transaction is declined, and either denying or reversing the preward allocation for offset (if previously authorized independently of the transaction or in advance of the transaction); and (A7) providing an authorization response from the issuer authorization processor to the acquiring entity via electronic communication on the network. Other payment gateway communication messaging includes (B1) providing a reversal request from the payment gateway to the issuer authorization processor via the network; (B2) sending a DI reversal request message to the DIS with reversal transaction data; (B3) providing a DI reversal response from the DIS acknowledging the reversal of the preward; and (B4) providing a reversal response to the payment gateway. Preferably, there is no communication regarding the preward between the DIS and the payment gateway directly, since the preward and DIS function do not directly affect merchant transactions.

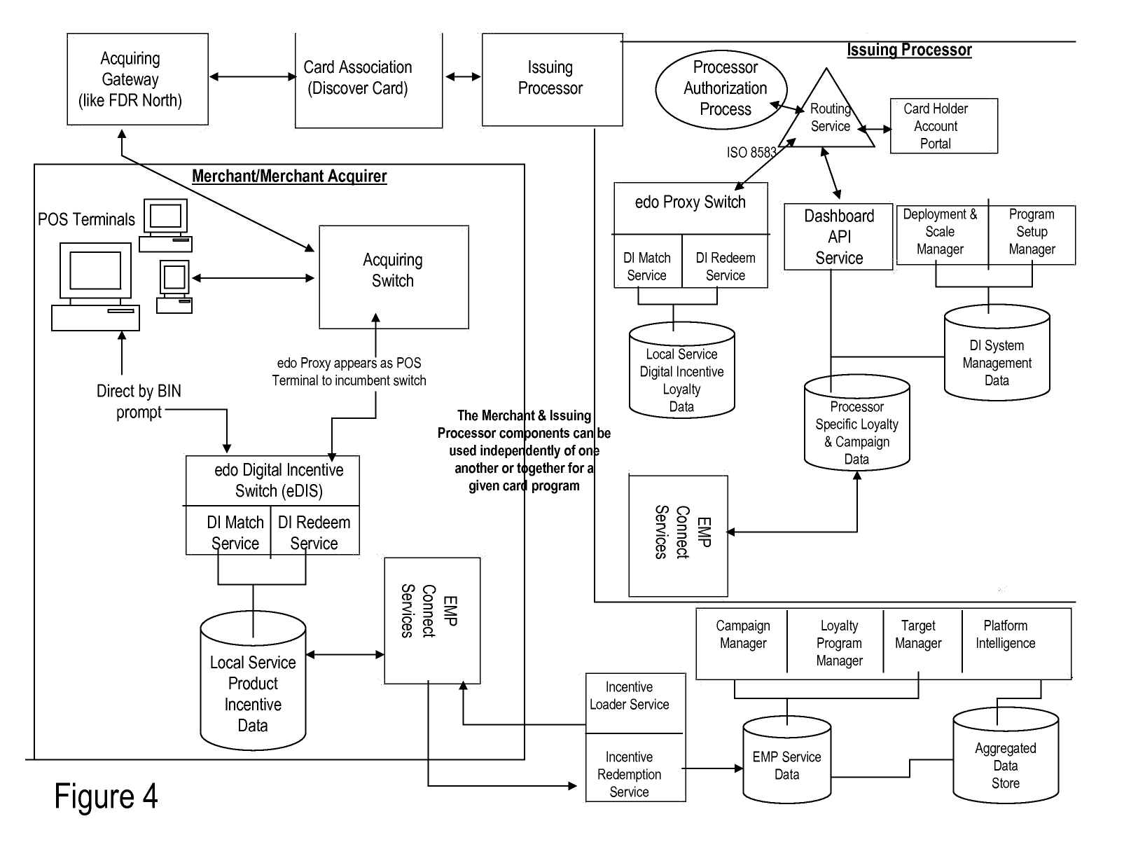

As shown in FIG. 4, another schematic and flow diagram of the digital incentive switch and switch processing for providing digital incentives within the system and methods of the present invention are illustrated.

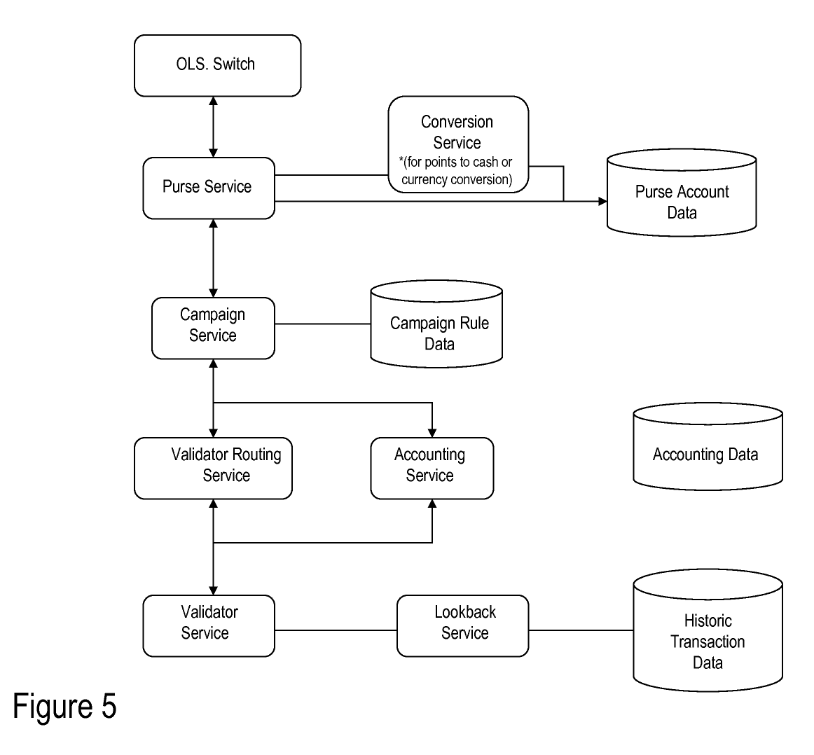

Referring now to FIG. 5, a schematic diagram of the digital incentive system and switch processing for providing digital incentives of the present invention is shown.

Significantly, the present invention systems and methods provide digital incentives within a financial system relating to merchant level transactions for goods and/or services, wherein the digital incentives impact the user account as an offset or credit and do not directly affect any aspect of the merchant level transaction, such as in the prior art discount or coupons, or as in the prepaid cards or advance rewards, wherein the merchant payment upon activation and use of the prepaid cards or advance rewards cards is a discounted payment, wherein the actual payment to the merchant is less than the retail transaction value for the payment for the goods and/or services at the time of purchase.

Certain modifications and improvements will occur to those skilled in the art upon a reading of the foregoing description. By way of example and not limitation, the preward digital incentive may be provided, authorized, and allocated based upon documentation included within a credit card user's statement; in this case, there digital incentives are indicated on the cardmember statement. Preferably, an interactive graphical user interface on a display related to a website accessible via a computer network provides the user with access to information about the digital incentives authorized, available, and/or selectable for use without affecting a purchase transaction at the merchant level (consistent with the foregoing methods); however, the matching is provided directly through the financial transactions recordation and documentation associated with the user financial statement, such as a credit card statement, and does not include the digital incentives switch interface, as with the other embodiments described in the foregoing. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A method for providing digital incentives or financial offsets comprising the steps of:
providing a financial platform operable on a server computer and at least one database in electronic, digital communication over a network, the financial platform operable for financial services transactions;
providing a database of profile data for the at least one user;
developing a digital incentive program for stimulating financial transactions by at least one user, the digital incentive program including profile factors from the profile data of the at least one user;
automatically providing at least one digital incentive to corresponding of the at least one user, the at least one digital incentive available for a redemption by each of the users, wherein the digital incentive has an electronic financial transaction value available for the redemption on any electronic financial transaction media, and wherein the redemption of the electronic financial transaction value of the digital incentive does not occur at a merchant level of the financial transactions.

2. The method of claim 1, further including the step of providing an electronic digital credit operable on any electronic financial transaction media.

3. The method of claim 1, further including the step of tracking the redemption of the digital incentive.

4. The method of claim 1, further including the step of reporting the redemption of the digital incentive.

5. The method of claim 1, wherein the financial services transactions include debit, credit, and prepaid electronic payment cards, wireless digital electronic device transactions, and bank account transactions.

6. The method of claim 1, wherein the financial services transactions are electronic financial transactions.

7. The method of claim 1, further including the step of collecting feedback from the users.

8. The method of claim 1, further including the step of providing an interactive user interface on a website operable for access by the at least one user to manage his/her digital incentives.

9. The method of claim 8, wherein website provides information about the number and type of digital incentives available for each of the at least one user.

10. The method of claim 8, wherein website provides information about the number and type of digital incentives previously applied for each of the at least one user.

11. The method of claim 1, further including the step of providing real-time statistical modeling and analysis based on tracking and feedback associated with the application of the digital incentives.

12. A method for providing digital incentives comprising the steps of:
providing a financial platform operable on a server computer and at least one database in electronic, digital communication over a network, the financial platform operable for financial services transactions;
providing a database of profile data for the at least one user;
developing a digital incentive program for stimulating financial transactions by at least one user, the digital incentive program including profile factors from the profile data of the at least one user;
automatically electronically providing at least one digital incentive to corresponding of the at least one user through the digital incentive program, the at least one digital incentive available for a redemption by each of the users, wherein the digital incentive has an electronic financial transaction value available for application via any electronic financial transaction media to offset a financial transaction at a bank level for the bank account, demand deposit account, credit, debit, or prepaid account of the at least one user, and wherein the application of the electronic financial transaction value of the digital incentive does not alter the financial transactions for the merchant accepting payment for the transaction.

13. A computer readable code stored in a storage medium and executable by one or more processors, which when executed perform the method steps comprising:
automatically providing an electronic communication for at least one digital incentive to a multiplicity of users, the at least one digital incentive available for a redemption by each of the users,
applying an electronic financial transaction value available for application triggered by use of the at least one digital incentive by corresponding users, via an electronic financial transaction media
providing a credit for the electronic financial transaction value at a financial institution level for the account, demand deposit account, credit, debit, or prepaid account of the at least one user, without directly affecting a merchant level of the financial transaction.

14. The code of claim 13, the code further including executable steps for tracking the use of the at least one digital incentive by the users.

15. The code of claim 13, the code further including executable steps for reporting results from tracking the use of the at least one digital incentive by the users.

16. The code of claim 13, wherein the code is operable for managing financial services and financial transactions associated with the electronic digital incentives.

17. A system for providing digital incentives comprising:
a financial system operable on a server computer and at least one database in electronic, digital communication over a network, the financial platform operable for financial services transactions;
the financial system interacting with a database of profile data for a multiplicity of users;
a digital incentive program operable within the financial system and the server computer for stimulating financial transactions by the users, the digital incentive program including profile factors from the profile data of the users and automatically providing at least one digital incentive to corresponding users, the at least one digital incentive available for a use by each of the users, wherein the digital incentive has an electronic financial transaction value available for the use on any electronic financial transaction media, and wherein the use of the electronic financial transaction value of the digital incentive does not alter the financial transactions for the merchant accepting payment for the transaction.

18. The system of claim 17, wherein the server computer transforms the financial transaction at a bank account level of each user, applying the financial transaction value available at the time of the financial transaction as a credit to each user.

19. The system of claim 17, wherein the system is accessible to a set of selected users via an interactive user interface on a website.
